(19) United States
(12) Patent Application Publication
(10) Pub. No.: US 2011/0273382 A1
(43) Pub. Date: Nov. 10, 2011

(54) TOUCH SCREEN HAVING ANTENNA PATTERN

(75) Inventors: Dong Sik YOO, Seoul (KR); Hee Bum LEE, Gyunggi-do (KR); Kyoung Soo CHAE, Gyunggi-do (KR); Yun Ki HONG, Gyunggi-do (KR); Yong Soo OH, Gyunggi-do (KR); Jong Young LEE, Gyunggi-do (KR)

(73) Assignee: SAMSUNG ELECTRO-MECHANICS CO ., LTD., Gyunggi-do (KR)

(21) Appl. No.: 12/833,636

(22) Filed: Jul. 9, 2010

(30) Foreign Application Priority Data
May 7, 2010 (KR) 10-2010-0043018

(51) Int. Cl. G06F 3/045

(52) U.S. Cl. 345/173

(57) ABSTRACT

Disclosed herein is a touch screen having an antenna, including: a first substrate that includes a first electrode pattern formed in an active region and a first electrode wiring formed in an inactive region disposed outside the active region and connected to the first electrode pattern; a second substrate that includes a second electrode pattern opposite to the first electrode pattern and a second electrode wiring connected to the second electrode pattern; a spacer that is formed between the first substrate and the second substrate to space the first electrode pattern from the second electrode pattern; and an antenna pattern that is formed in the inactive region.

### CROSS REFERENCE TO RELATED APPLICATION

This application claims the benefit of Korean Patent Application No. 10-2010-0043018, filed on May 7, 2010, entitled “Touch Screen Having Antenna Pattern”, which is hereby incorporated by reference in its entirety into this application.

### BACKGROUND OF THE INVENTION

1. Technical Field

The present invention relates to a touch screen having an antenna pattern.

2. Description of the Related Art

In general, a touch screen is an input device that inputs corresponding instructions by pressing the position of a key displayed on a terminal with an input member such as fmgers or a pen. The applicable fields of the touch screen have been expanding.

In recent, with the development of the mobile communication technology, terminals such as cellular phones, PMPs, PDAs, and navigations have been expanding their functions as more various and complicated multimedia providing means such as audio, moving pictures, radio Internet web browser, etc. in addition to a simple text information display means. In addition, a larger display screen is required to be implemented within a limited size of a terminal, such that a display scheme using a touch screen has been further in the limelight.

The terminals described above use a short range radio communication module so as to transfer electronic information therebetween. The short range radio communication module may be bluetooth, WiFi, Zigbee, RFTD communication modules. The terminals described above have an antenna so as to transfer electronic information through such a radio communication module.

However, the antenna attached to the terminal according to the prior art is separately configured inside the terminal, thereby complicating the internal structure of the terminal The antenna separately configured increases the manufacturing costs of the terminal and complicates the manufacturing process thereof.

### SUMMARY OF THE INVENTION

The present invention has been made in an effort to provide a touch screen having an antenna pattern that can reduce manufacturing costs and improve freedom in design of a terminal by mounting an antenna transmitting and receiving electronic information according to a signal of a short range radio communication module on the touch screen mounted on a terminal.

A touch screen having an antenna according to a preferred embodiment of the present invention includes: a first substrate that includes a first electrode pattern formed in an active region and a first electrode wiring formed in an inactive region disposed outside the active region and connected to the first electrode pattern; a second substrate that includes a second electrode pattern opposite to the first electrode pattern and a second electrode wiring connected to the second electrode pattern; a spacer that is formed between the first substrate and the second substrate to space the first electrode pattern from the second electrode pattern; and an antenna pattern that is formed in the inactive region.

Further, the antenna pattern is formed in the inactive region of the first substrate and is formed outside the first electrode wiring.

Further, the antenna pattern is formed in the inactive region of the second substrate and is formed outside the second electrode wiring.

Further, the antenna pattern is made of the same material as that of the first electrode pattern or the first electrode wiring.

Further, the antenna pattern is made of a transparent conductive polymer.

Further, an end of the first electrode wiring, an end of the second electrode wiring, and an end of the antenna pattern are collected at a connection unit formed at one side of the touch screen.

Further, the touch screen is a resistive touch screen or a capacitive touch screen.

### BRIEF DESCRIPTION OF THE DRAWINGS

FIG. 1 is an exploded perspective view schematically showing a touch screen having an antenna pattern according to a preferred embodiment of the present invention;

FIG. 2 is a cross-sectional view of the touch screen of FIG. 1;

FIG. 3 is a plan view showing a first substrate on which the antenna pattern of the touch to screen of FIG. 1 is formed;

FIG. 4 is an exploded perspective view schematically showing a touch screen according to another preferred embodiment of the present invention;

FIG. 5 is an exploded perspective view schematically showing a touch screen according to still another preferred embodiment of the present invention;

FIG. 6 is a cross-sectional view of the touch screen of FIG. 5;

FIG. 7 is a plan view showing a first substrate on which the antenna pattern of the touch screen of FIG. 5 is formed; and

FIG. 8 is a cross-sectional view showing a modified example of the touch screen of FIG. 5.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

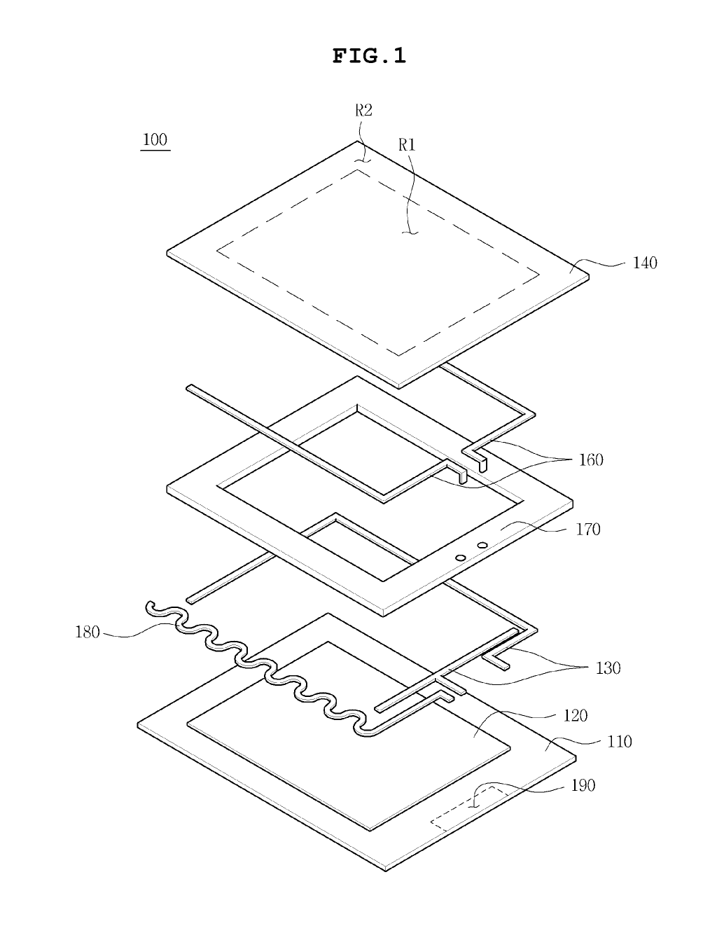

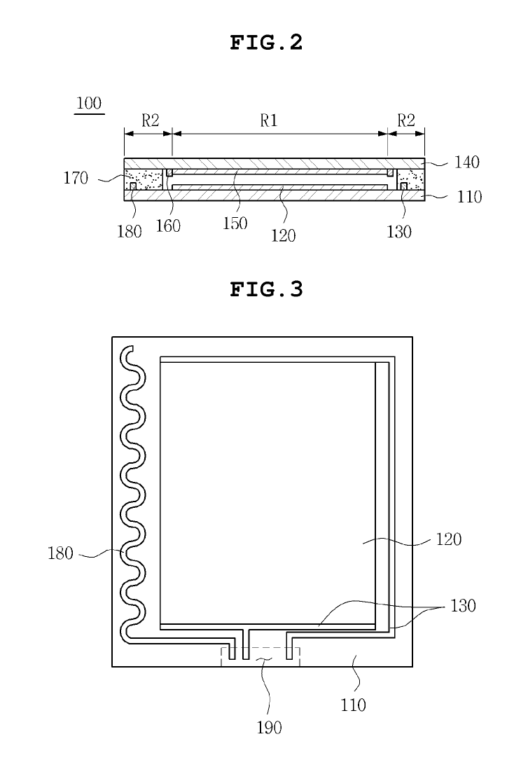

FIG. 1 is an exploded perspective view schematically showing a touch screen having an antenna pattern according to a preferred embodiment of the present invention, FIG. 2 is a cross-sectional view of the touch screen of FIG. 1, and FIG. 3 is a plan view showing a first substrate on which the antenna pattern of the touch screen of FIG. 1 is formed. Hereinafter, a touch screen having an antenna pattern according to the present embodiment will be described with reference to the figures.

A touch screen 100 having an antenna pattern (hereinafter, referred to as a touch screen) according to the present invention includes two opposite substrates on which electrode patterns and electrode wirings are formed, wherein the two substrates are spaced from each other by a spacer and an antenna pattern connected to a short range radio communication module is formed in an inactive region of the touch screen.

A first substrate 110 includes an active region R1 on which a first electrode pattern 120 is formed and an inactive region R2, on which a first electrode wiring 130 connected to the first electrode pattern 120 is formed, the inactive region R2 being disposed outside the active region R1. Herein, the active region R1 and the inactive region R2 are defined according to the functions of the touch screen, wherein the active region R1 is a region through which an image generated from a display disposed at the lower side of the touch screen 100 passes and the inactive region R2 is a region through which images do not pass.

The first substrate 110 configuring the touch screen 100, which is a transparent member, may use a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylenenaphatalenedicarboxylate (PEN), polycarbonate (PC), polyethersulfone (PES), polyimide (PI), polyvinylalcohol (PVA), cyclic olefm copolymer (COC), stylene polymer, polyethylene, polypropylene, etc. and is not particularly limited.

The first electrode pattern 120 may be made of ITO, a carbon nanotube, a transparent conductive polymer, wherein the conductive polymer may adopt polythiophene, polypyrrole, polyaniline, polyacetylene, polyphenylene polymers, etc. as organic compounds. In particular, among the polythiophene-based compounds, a PEDOT/PSS compound is most preferable and a mixture of one or more compounds among the organic compounds may be used. At this time, when the touch screen 100 is a resistive type, as shown in FIG. 1, the first electrode pattern 120 has a thin film shape.

In addition, the first electrode wiring 130 is connected to the first electrode pattern 120 and transfers change in voltage generated depending on the contact of the electrode pattern to a controller (not shown). The first electrode wiring 130 is configured of two wirings formed in a Y direction, as shown in FIG. 1. The first electrode wiring 130 may be made of a conductive material and be made of the same material as that of the first electrode pattern 120 or silver (Ag).

A second substrate 140, disposed to be opposite to the first substrate 110, includes an active region R1 on which a second electrode pattern 150 is formed so as to be opposite to the first electrode pattern 120 and an inactive region R2 on which a second electrode wiring 160 connected to the second electrode pattern 150 is formed, the inactive region R2 being disposed outside the active region R1.

The shape and material of the second electrode pattern 150 and the second electrode wiring 160 may be constituted to be the same as those of the first electrode pattern 120 and the first electrode wiring 130 and therefore, the detailed description thereof will be omitted. However, the second electrode wiring 160 is formed in an X direction.

At this time, it is preferable that the ends of the first electrode wiring 130 and the second electrode wiring 160 are collected at a connection unit 190 formed at one side of the touch screen, as shown in FIG. 1. The change in voltage generated in the electrode pattern is transmitted to the controller through a FPC (not shown) connected to the connection unit 190. When the connection unit 190 is formed at one side of the first substrate 110 as shown in FIGS. 1 and 2, the end of the second electrode wiring 160 formed on a plane other than the first substrate 110 is collected at the connection unit 190 by passing through a spacer 170.

The spacer 170 that spaces the first electrode pattern 120 from the second electrode to pattern 150 is positioned between the first substrate 110 and the second substrate 120, wherein the spacer 170 has a shape that its inside is open. The first electrode pattern 120 contacts the second electrode pattern 150 due to external pressure to measure the change in voltage accordingly, thereby detecting coordinates of a contact point. As the spacer 170, a double-sided adhesive sheet may be used.

The touch screen 100 according to the present invention has an antenna pattern 180 formed in the inactive region R2, as shown in FIGS. 1 to 3. The antenna pattern 180 may be connected to a short range radio communication module (not shown) that transmits and receives electronic information and is constituted in a terminal through the FPC (not shown).

When the antenna pattern 180 is formed in the inactive region R2 of the first substrate 110, it is preferable that the antenna pattern 180 is formed in a region where the first electrode wiring 130 is not formed as shown in FIG. 2. Further, the antenna pattern 180 may be formed in the inactive region R2 of the first substrate and in the inactive region R2 of the second substrate, which may be connected to each other. The antenna pattern 180 having the structure described above does not affect the configuration of the touch screen 100 and is configured within the touch screen, thereby making it possible to improve freedom in design of the terminal on which the touch screen is mounted. In addition, the antenna pattern 180 may also be formed in the inactive region R2 of the second substrate 140.

Although the antenna pattern 180 shown in FIGS. 1 to 3 has a shape of continuous bent patterns (a plane coil shape), it is not limited thereto but may also have a straight shape or other known shapes according to a use frequency of the short range radio communication module.

At this time, it is preferable that the end of the antenna pattern 180 is collected at the connection unit 190 formed at one side of the touch screen 100, similar to the ends of the first electrode wiring 130 and the second electrode wiring 160. The antenna patterns 180 may be connected to the short range radio communication module in regions other than the connection unit 190 through the FPC. However, when the antenna patterns 180 are collected at the connection unit 190, similar to the electrode wirings, they may be connected to the short range communication module and the controller, respectively, through one PFC and thus, a plurality of connection units are not required.

It is preferable that the antenna pattern 180 is made of the same material as that of the first electrode pattern 120 or the first electrode wiring 130. The first electrode pattern 120 and the first electrode wiring 130 may be formed on the first substrate 110 by an inkjet printing method or a gravure printing method. When the antenna pattern 180 is made of the same material as that of the first electrode pattern 120 or the first electrode wiring 130, the antenna pattern 180 can be formed simultaneously with forming the first electrode pattern 120 or the first electrode wiring 130, such that the manufacturing process is simplified and productivity is improved.

Therefore, the antenna pattern 180 may be made of ITO, carbon nanotubes or a transparent conductive polymer and preferably, made of the transparent conductive polymer having the cheapest manufacturing unit cost and being appropriate for the printing methods described above. The antenna pattern 180 made of the transparent conductive polymer cannot be recognized by a user outside, such that the terminal on which the touch screen is mounted may remove a bezel structure to cover the antenna pattern 180.

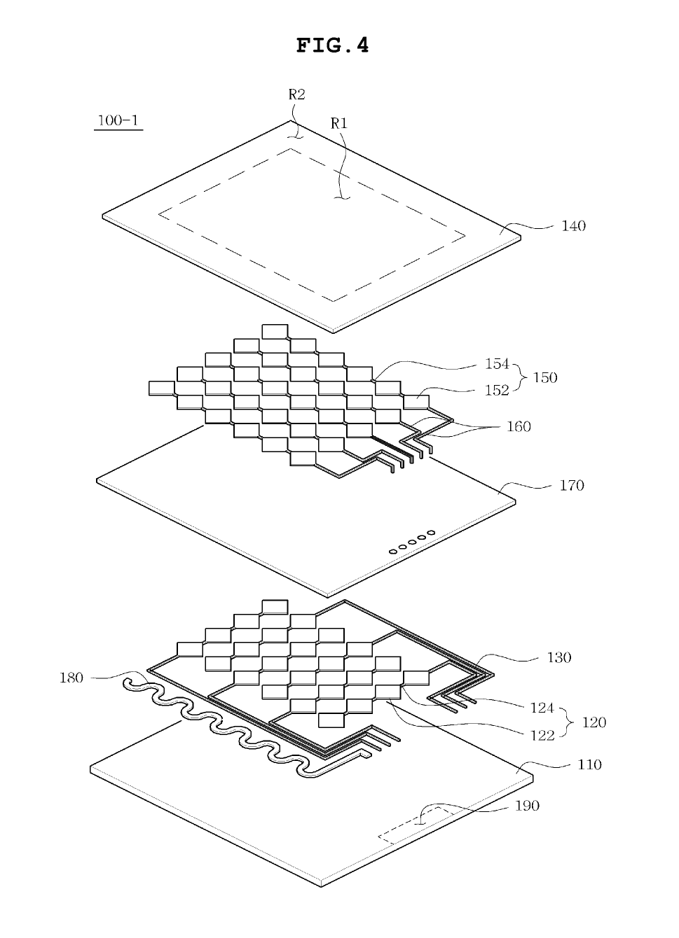

FIG. 4 is an exploded perspective view showing a touch screen according to still another preferred embodiment of the present invention. The touch screen according to the present embodiment is a capacitive touch screen. The antenna pattern of the present embodiment, connected to a short range radio communication module, is formed in an inactive region R2 of the touch screen. Hereinafter, the touch screen according to the present embodiment will be described with reference to FIG. 4.

A touch screen 100-1 (hereinafter, referred to as a touch screen) according to the present embodiment includes two opposite substrates on which electrode patterns and electrode wirings are formed, wherein the two substrates are spaced from each other by a spacer and an antenna pattern connected to a short range radio communication module is formed in an inactive region of the touch screen.

The first substrate 110 disposed at the lower side and the second substrate 140 disposed at the upper side, which are transparent members, may use a glass substrate, a film substrate, a fiber substrate, or the like, as described with reference to FIGS. 1 to 3.

At this time, a plurality of first electrode patterns 120 are formed in an active region R1 of the first substrate 110, including sensing units 122 and connection units 124, and are formed in a Y direction. First electrode wirings 130 connected to the first electrode patterns 120 are formed in an inactive region R2.

The first electrode pattern 120 and the first electrode wiring 130 may be made of the same materials as those of the electrode pattern and the electrode wiring described with reference to FIGS. 1 to 3 and therefore, the detailed description thereof will be omitted.

Further, second electrode patterns 150 are formed on the second substrate 140 in an X direction, to be opposite to the first electrode patterns 120. The second electrode patterns 150 also include sensing units 152 and connection units 154 and are connected with the second electrode wiring 160.

A spacer 170 having a plan member shape capable of completely spacing the first electrode patterns 120 from the second electrode patterns 150 is coupled to the first substrate 110 and the second substrate 140 by an optical clear adhesive.

In addition, the antenna pattern 180 is also formed in the inactive region R2 of the first substrate 110. The antenna pattern 180 may be connected to a short range radio communication module (not shown) that transmits and receives electronic information and is constituted in a terminal through the FPC (not shown).

Meanwhile, still another embodiment of the present invention will describe a resistive touch screen of by way of example, however, it is obvious that this may also be applied to the capacitive touch screen described with reference to FIG. 4.

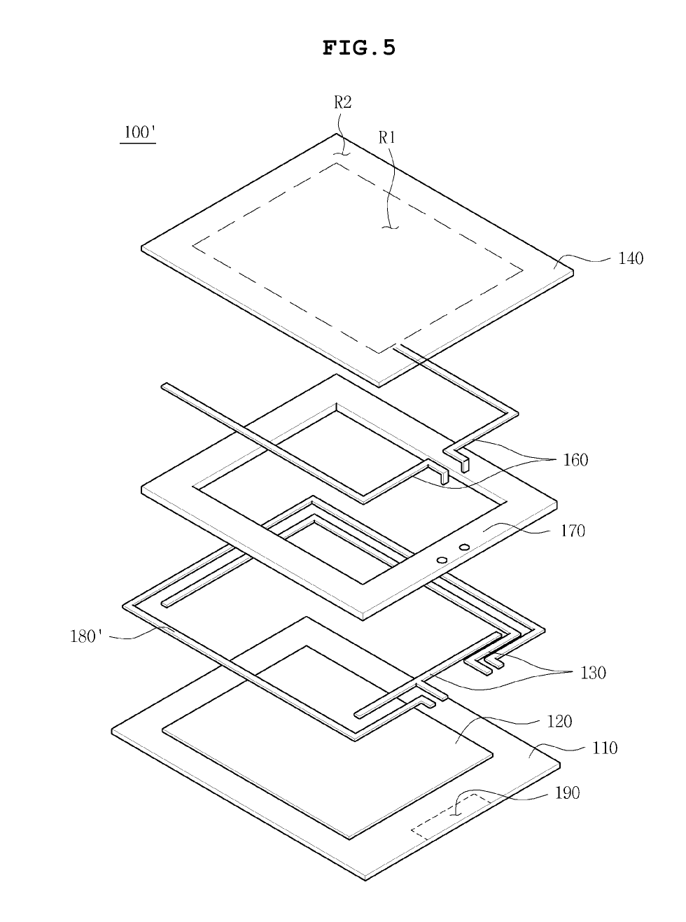

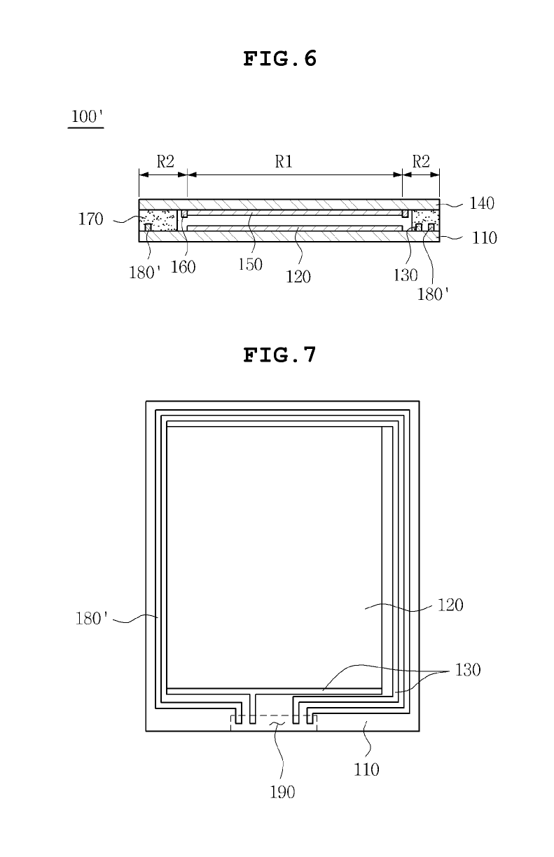

FIG. 5 is an exploded perspective view schematically showing a touch screen according to still another preferred embodiment of the present invention, FIG. 6 is a cross-sectional view of the touch screen of FIG. 5, and FIG. 7 is a plan view showing a first substrate on which the antenna pattern of the touch screen of FIG. 5 is formed. Hereinafter, the touch screen according to the present embodiment will be described with reference to these figures. A detailed description of the same configuration as that described with reference to FIGS. 1 to 3 will be omitted.

A touch screen 100′ according to the present embodiment has an antenna pattern 180′ formed in an inactive region R2 of a first substrate 110 and is formed outside a first electrode wiring 130. Therefore, the antenna pattern 180′ has a loop shape. When the antenna pattern 180′ is formed in the inactive region R2, an image generated from a display can be transferred to the outside without interruption and when the antenna pattern 180′ is formed outside the first electrode wiring 130, a short-circuit that may occur between the antenna pattern 180′ and the first electrode wiring 130 can be prevented.

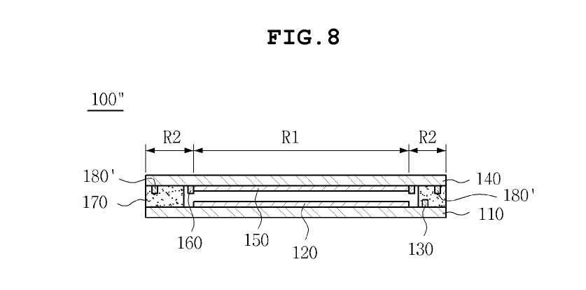

A touch screen 100″ according to still another embodiment may have an antenna pattern 180′ formed in an inactive region R2 of the second substrate 140 rather than the first substrate 110 and be formed outside the second electrode wiring 160, as shown in FIG. 8.

According to the present invention, the antenna of the short range radio communication module is formed on the touch screen, thereby making it possible to improve freedom in design of the terminal mounted on the touch screen, reduce the manufacturing costs, and simplify the manufacturing process.

In addition, according to the present invention, the antenna pattern formed on the touch screen is made of the same material as that of the electrode pattern of the touch screen, thereby making it possible to simplify the manufacturing process, and the antenna pattern is made of the transparent conductive polymer, thereby making it possible to remove a bezel structure from the terminal

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch screen having an antenna pattern, comprising:
a first substrate that includes a first electrode pattern formed in an active region and a first electrode wiring formed in an inactive region disposed outside the active region and connected to the first electrode pattern;
a second substrate that includes a second electrode pattern opposite to the first electrode pattern and a second electrode wiring connected to the second electrode pattern;
a spacer that is formed between the first substrate and the second substrate to space the first electrode pattern from the second electrode pattern; and
an antenna pattern that is formed in the inactive region.

2. The touch screen having an antenna pattern as set forth in claim 1, wherein the antenna pattern is formed in the inactive region of the first substrate and is formed outside the first electrode wiring.

3. The touch screen having an antenna pattern as set forth in claim 1, wherein the antenna pattern is formed in the inactive region of the second substrate and is formed outside the second electrode wiring.

4. The touch screen having an antenna pattern as set forth in claim 1, wherein the antenna pattern is made of the same material as that of the first electrode pattern or the first electrode wiling.

5. The touch screen having an antenna pattern as set forth in claim 4, wherein the antenna pattern is made of a transparent conductive polymer.

6. The touch screen having an antenna pattern as set forth in claim 1, wherein an end of the first electrode wiring, an end of the second electrode wiring, and an end of the antenna pattern are collected at a connection unit formed at one side of the touch screen.

7. The touch screen having an antenna pattern as set forth in claim 1, wherein the touch screen is a resistive touch screen or a capacitive touch screen.
